(19) United States
(12) Patent Application Publication
(10) Pub. No.: US 2012/0075955 A1
(43) Pub. Date: Mar. 29, 2012

(54) EFFICIENT SEISMIC SOURCE OPERATION IN CONNECTION WITH A SEISMIC SURVEY

(76) Inventor: TIMOTHY DEAN, Subiaco (AU)

(21) Appl. No.: 13/167,612

(22) Filed: Jun. 23, 2011

Related U.S. Application Data
(60) Provisional application No. 61/387,319, filed on Sep. 28, 2010.

(51) Int. Cl. G01V 1/04

(52) U.S. Cl. 367/41

(57) ABSTRACT

An embodiment includes determining whether first and second seismic sources are ready to perform seismic sweeps. When either of the first and the second seismic sources are determined to be unready to perform seismic sweeps, the method includes (a) determining a predicted time delay that will transpire before the first and the second seismic sources will both be ready to perform seismic sweeps; (b) determining a predicted distance that will exist between the first and second seismic sources once the first and second sources are both ready to perform seismic sweeps; (c) determining the predicted time delay meets a time threshold and the predicted distance meets the distance threshold, and then (d) initiating simultaneous seismic sweeping with the first and second seismic sources after the first and the second seismic sources are both ready to perform seismic sweeps

### CROSS-REFERENCE TO RELATED APPLICATION

This application claims priority to U.S. Provisional Patent Application No. 61/387,319 filed on Sep. 28, 2010 and entitled “Enhanced Productivity in Simultaneous Seismic Survey Acquisition Through Prediction of Source Positions and Variation in Queue Discipline,” the content of which is hereby incorporated by reference.

### BACKGROUND

Seismic exploration may involve surveying subterranean geological formations (e.g., for hydrocarbon and/or other deposits). A survey may involve deploying seismic source(s) and seismic sensors at predetermined locations. The sources generate seismic waves, which propagate into the geological formations creating pressure changes and vibrations along their way. Changes in the elastic properties of the geological formation scatter the seismic waves, changing their direction of propagation and other properties. Part of the energy emitted by the sources reaches the seismic sensors. Some seismic sensors are sensitive to pressure changes (e.g., hydrophones) and others are sensitive to particle motion (e.g., geophones). Industrial surveys may deploy only one type of sensor or both. In response to the detected seismic events, the sensors generate electrical signals to produce seismic data. Analysis of the seismic data can then indicate the presence or absence of probable locations of hydrocarbon or mineral deposits.

A type of seismic source is a seismic vibrator, which is used in connection with a “vibroseis” survey. For a seismic survey that is conducted on dry land, the seismic vibrator imparts a seismic source signal into the earth, which has a relatively lower energy level than the signal that is generated by an impulsive energy source. However, the energy that is produced by the seismic vibrator's signal is transmitted over a relatively longer period of time. Land seismic surveys may consist of lines of source and receiver points. The sources (e.g., hydraulic seismic vibrators) may acquire data at each source point. Acquisition in modern systems may be “source driven” such that as the source reaches its next survey point it sends a “ready tone” to the acquisition system. After receiving the “ready tone” the acquisition system triggers the source.

Simultaneous source acquisition involves two or more groups of sources emitting sweeps simultaneously. For example, each sweep may start at the same instant, end at the same instant, and/or merely overlap (e.g., slip-sweep acquisition) to some extent. Simultaneous sweep methods may involve the sources being separated by a distance large enough such that the energy from the various sources does not cause interference in the area of interest (e.g., “distance separated simultaneous sources”) or by a smaller, though still considerable distance, combined with a random jitter in the start times. The selection of the sources that operate simultaneously in such methods may be done dynamically (i.e., fleets are not fixed in groups).

### BRIEF DESCRIPTION OF THE DRAWINGS

Features and advantages of embodiments of the invention will become apparent from the appended claims, the following detailed description of one or more example embodiments, and the corresponding figures, in which:

FIGS. 1 and 2 are schematic diagrams of acquisition systems in embodiments of the invention.

FIG. 3 includes a flow diagram for queue discipline in an embodiment.

FIG. 4 illustrates an example of seismic surveying in an embodiment.

FIG. 5 includes a flow diagram for queue discipline in an embodiment.

FIG. 6 illustrates an example of seismic surveying in an embodiment.

FIG. 7 includes a flow diagram for queue discipline in an embodiment.

FIG. 8 includes a flow diagram for queue discipline in an embodiment.

FIG. 9 includes a system for use in various embodiments of the invention.

### DETAILED DESCRIPTION

In the following description, numerous specific details are set forth but embodiments of the invention may be practiced without these specific details. Well-known circuits, structures and techniques have not been shown in detail to avoid obscuring an understanding of this description. “An embodiment”, “example embodiment”, “various embodiments” and the like indicate embodiment(s) so described may include particular features, structures, or characteristics, but not every embodiment necessarily includes the particular features, structures, or characteristics. Some embodiments may have some, all, or none of the features described for other embodiments. “First”, “second”, “third” and the like describe a common object and indicate different instances of like objects are being referred to. Such adjectives do not imply objects so described must be in a given sequence, either temporally, spatially, in ranking, or in any other manner. “Coupled” and “connected” and their derivatives are not synonyms. “Connected” may indicate elements are in direct physical or electrical contact with each other and “coupled” may indicate elements co-operate or interact with each other, but they may or may not be in direct physical or electrical contact. Also, while similar or same numbers may be used to designate same or similar parts in different figures, doing so does not mean all figures including similar or same numbers constitute a single or same embodiment.

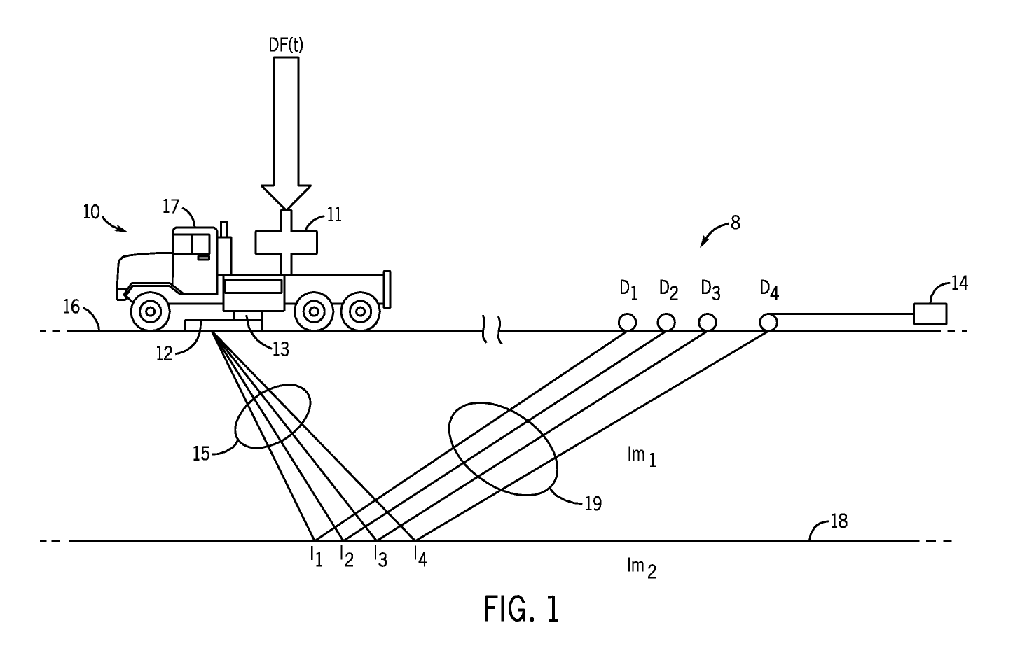

FIG. 1 includes a schematic diagram of an acquisition system in an embodiment. A land-based vibroseis acquisition system 8 may include mobile seismic sources, such as seismic vibrator 10. Vibrator 10 may be one of a fleet of mobile seismic sources which, in turn is one of a number of fleets, or groups, which move along respective source lines for purposes of conducting a geophysical seismic survey. For simplicity, single vibrator 10 is depicted in FIG. 1. Acquisition system 8 may also include surface-located geophones D₁, D₂, D₃ and D₄ and data acquisition system 14. Seismic vibrator 10 may include signal measuring apparatus 13, which includes sensors (accelerometers, for example) to measure seismic source signal 15 (i.e., to measure the output force of seismic vibrator 10). Seismic vibrator 10 may be mounted on truck 17 to enhance vibrator mobility.

To perform the survey, each seismic vibrator 10 generates a seismic source signal 15. Interface 18 between subsurface impedances Im₁ and Im₂ reflects signal 15 at points I₁, I₂, I₃ and I₄ to produce reflected signal 19 that is detected by geophones D₁, D₂, D₃ and D₄; respectively. Data acquisition system 14 gathers the raw seismic data acquired by the geophones D₁, D₂, D₃ and D₄, and the raw seismic data may be processed to yield information about subsurface reflectors and the physical properties of subsurface formations. For purposes of generating seismic source signal 15, seismic vibrator 10 contains a hydraulic actuator that drives vibrating element 11 in response to a driving signal (called “DF(t)”). More specifically, driving signal DF(t) may be a sinusoid whose amplitude and frequency are changed during the sweep. Because the vibrating element 11 is coupled to base plate 12 that is in contact with earth surface 16, the energy from element 11 is coupled to the earth to produce seismic source signal 15. Vibrating element 11 may contain a reaction mass that oscillates at a frequency and amplitude that is controlled by the driving signal DF(t): the frequency of the driving signal DF(t) sets the frequency of oscillation of the reaction mass; and the amplitude of the oscillation, in general, is controlled by a magnitude of the driving signal DF(t). During the sweep, the frequency of the driving signal DF(t) may transition (and thus, the oscillation frequency of the reaction mass transitions) over a continuous range of frequencies. The amplitude of the driving signal DF(t) may also vary during the sweep pursuant to a designed amplitude-time envelope.

In an embodiment, vibrating element 11 may be driven by an actuator other than a hydraulic actuator. For example, vibrating element 11 may be driven by an electro-magnetic actuator. Additionally, in an embodiment seismic vibrator 10 may be located in a borehole and thus, may not be located at the surface. In an embodiment seismic sensors, such as geophones, may alternatively be located in a borehole. Therefore, although specific examples of surface-located seismic vibrators and seismic sensors are set forth herein, it is understood that the seismic sensors, the seismic vibrator, or both of these entities may be located downhole. Thus, many variations are contemplated and are within the scope of the appended claims.

As noted above, seismic vibrator 10 is one of a number of mobile seismic sources that may be used in a particular seismic survey. In this manner, a typical land-based seismic survey includes multiple source lines and receiver points. The seismic sources, such as seismic vibrators, typically are used to acquire seismic data at source points along the lines. In a typical configuration, groups of seismic vibrator(s) may be disposed along respective source lines such that the seismic vibrators emit seismic energy at different source points along their respective source lines.

Acquisition in modern seismic acquisition systems may be “source driven,” as the seismic source may send a “ready tone” or “request” to the acquisition system to alert the acquisition system that the source is ready to generate seismic energy at that point. The acquisition system typically processes these requests in the order in which the requests are received; and a given seismic source does not generate seismic energy until the corresponding request is granted by the seismic acquisition system. If there are sufficient seismic sources available, then a virtual queue is formed, which contains the pending requests.

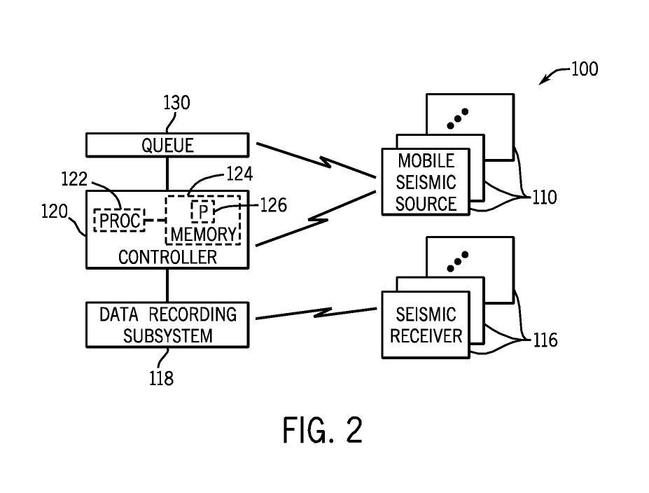

FIG. 2 includes a schematic diagram of an acquisition system in an embodiment. Seismic acquisition system 100 includes mobile seismic sources 110 and seismic receivers 116. System 100 may include data recording subsystem 118 that is coupled to receive seismic measurements from seismic receivers 116. In an embodiment, sources 110 may communicate wirelessly (or via hardwire) with controller 120 and queue 130 (discussed further below); receivers 116 may communicate wirelessly with data recording subsystem 118 or may communicate with subsystem 118 via a hardwire connection. System 100 may include controller 120, which receives ready tones from seismic sources 110. For example, activation or initiation of seismic source 110 may include the transmission of a signal from controller 120 to source 110 granting source 110 permission to emit seismic energy. The activation of source 110 may involve a subset of these acts, in accordance with other implementations. However, in an embodiment the request that is communicated by a given source 110 indicates that source 110 is ready to take an action in the seismic survey; and seismic source 110 awaits authorization from controller 120 (in response to the request) before taking that action.

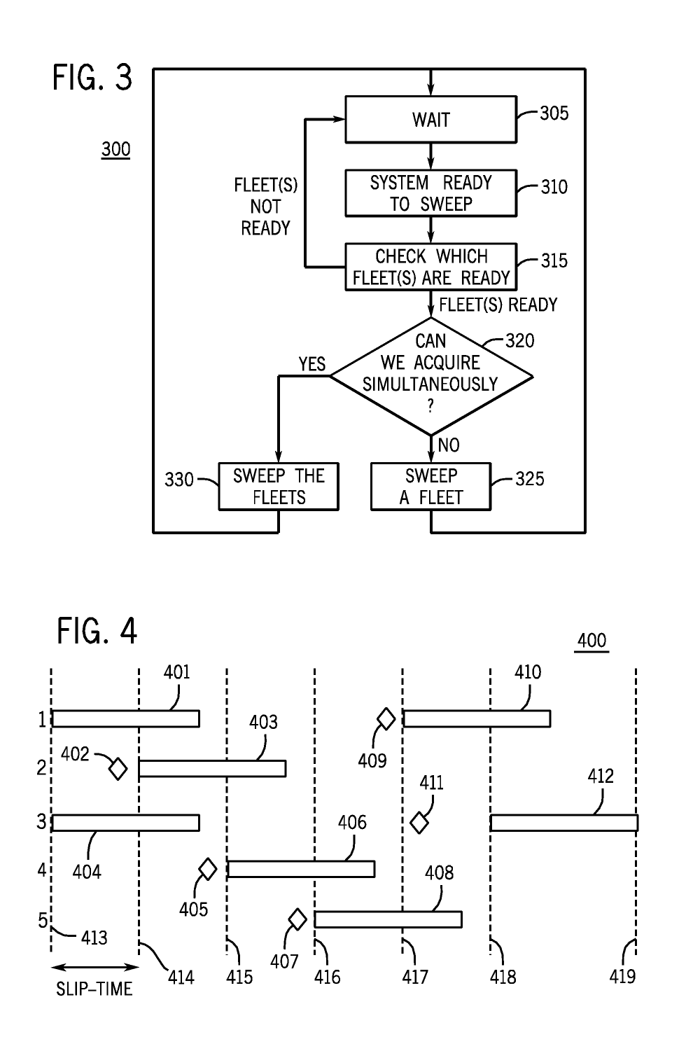

FIG. 3 includes a flow diagram for queue discipline in an embodiment. Referring to FIGS. 1 and 3, in block 305 system 14 waits to perform seismic testing. For example, wait time in block 305 may include a minimum time between consecutive seismic sweeps such as, for example, the slip-time. Slip-time includes the minimum time interval between the shooting times of two consecutive sweeps. Slip-time may be sweep length plus the listen time but may also be set to a shorter time.

In block 310, recording system 14 may determine whether it is ready to sense or record seismic testing. In block 315, system 14 may determine whether first and second seismic sources 10 are ready to perform seismic sweeps. For example, once the slip-time has expired since the previous sweep, then system 14 may check which fleet(s) have reported “ready”.

If no sources are ready, system 14 may delay testing and return to block 305 to wait (e.g., until receiving a “ready” signal from source 10). However, if a source is ready system 14 may determine (block 320) whether simultaneous sweeping may occur. For example, if first and the second seismic sources are determined to both be ready to perform seismic sweeps, in block 330 system 14 may initiate simultaneous seismic sweeping with the first and second seismic sources based on determining a distance between the first and second seismic sources meets a distance threshold. For example, system 14 may look at the relative geographical positions of the “ready” sources and determine which fleets or sources are sufficiently separated and can therefore be acquired simultaneously. If the fleets or sources are far enough apart then they may be acquired simultaneously. Testing efficiency may increase by acquiring as many fleets simultaneously as possible. Increasing the number of available sources may further increase the efficiencies possible with simultaneous sweeping.

However, if only one source is ready system 14 may elect to forego simultaneous sweeping and simply conduct a sweep with a single fleet or source (block 325). Also, two or more sources may be ready to sweep but may be too close to one another for simultaneous sweeping. In such a situation, again system 14 may elect to forego simultaneous sweeping and simply conduct a sweep with a single fleet or source (block 325). Afterwards, system 14 waits at block 305.

FIG. 4 illustrates an example of seismic surveying in an embodiment. Vibrator fleets 1, 2, 3, 4, and 5 are shown along with vertical lines 413, 414, 415, 416, 417, 418, which represent various slip times. Bars 401, 403, 404, 406, 408, 410, 412 represent sweeps from the fleets and diamonds 402, 405, 407, 409, 411 indicate when the fleets are “ready” to acquire their respective next source points. Line 419 indicates the total time required to acquire seven sweeps (401, 403, 404, 406, 408, 410, and 412). Initially fleets 1 and 3 sweep simultaneously (401, 404), followed by fleet 2 (403), then fleet 4 (406) and fleet 5 (408). In this example, fleet 1 arrives at its next source point before fleet 3 (e.g., possibly fleet 3 is running behind schedule due to an equipment malfunction) and as slip-time 417 has expired, only fleet 1 is acquired. Fleet 3 then arrives but has to wait for slip-time 418 before it can be acquired.

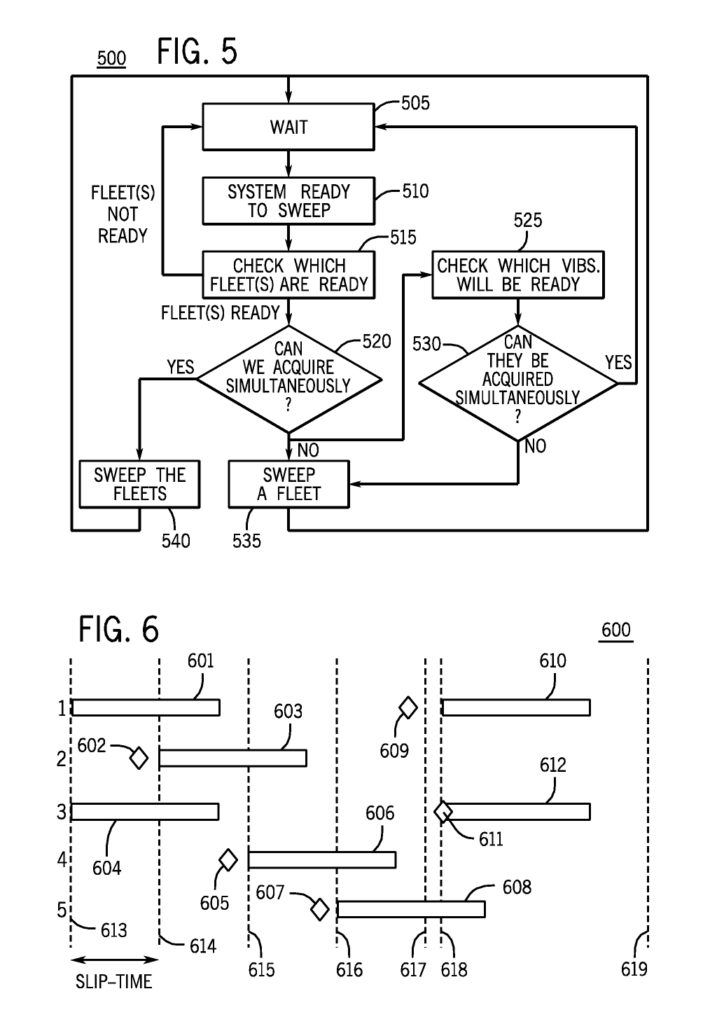

However, as addressed in FIG. 5, incorporating predictions and delays may actually increase testing efficiency. Portions of FIG. 5 are analogous to FIG. 3. For example, blocks 505, 510, 515, 520, 535 and 540 respectively correspond to blocks 305, 310, 315, 320, 325 and 330. However, FIG. 5 also includes blocks 525 and 530. Specifically, in block 525 when either of first and second seismic sources is determined to be unready to perform seismic sweeps, system 14 may determine a predicted time delay that will transpire before the first and the second seismic sources will both be ready to perform seismic sweeps. Also, system 14 may determine whether the predicted time delay meets a time threshold. In block 530, system 14 may determine a predicted distance that will exist between the first and second seismic sources once the first and second sources are both ready to perform seismic sweeps. System 14 may also determine the predicted distance meets the distance threshold. System 14 may determine the predicted distance based on data concerning generally real-time location tracking for one of several seismic sources.

If both of the predicted time and distance restraints are met, system 14 may institute a delay and return to block 505 (to later initiate simultaneous seismic sweeping after a delay with the first and second seismic sources after the first and the second seismic sources are both ready to perform seismic sweeps). However, if either of the predicted time and distance restraints is not be met system 14 may instead progress to block 535 to initiate, for example, a non-simultaneous sweep without further delay.

Regarding prediction of time and distance for sources not yet ready for testing, there are various embodiments for making the predictions. For example, such predictions may be based on real-time tracking of vibrator positions (e.g., using GPS systems). Source location, direction, speed, and route of travel may be used for the prediction. Also, predictions may be based on prediction of move-up times that take into account data concerning previous move-up times. A move-up time includes the time for one vibrator or a fleet of vibrators to move from one sweep location to the next. Thus, system 14 may determine the predicted time delay based on data concerning a previous move-up time for one of several sources. For example, system 14 may account for source model X or testing crew X having a move-up time of A seconds and source model Y or testing crew Y having a move-up time of B seconds. Thus, when system 14 determines (e.g., based on communication from a source) that a source has completed its sweep and its listening time then system 14 may be able to forecast the length of delay until the source will be at the next sweep location. As an additional example, system 14 could predict the time when the next sweep will begin as soon as the current sweep has begun. For example, if a sweep is 12 seconds long, the move-up time is 20 seconds, and the start time for the current sweep is 8:12:20, then the estimated start time for the next sweep is 8:12:52. Also, the vibrator may begin moving as soon as its sweep is complete (i.e., vibrator does not have to wait for the listen time). As another example, the above predictions may be further aided by a source telling system 14 when the source is nearly ready to sweep. With this information system 14 may better determine it should wait for the next fleet to arrive and get “ready” so their sweeps can be acquired simultaneously or if the wait would be too long and hinder efficiency. Thus, system 14 may receive communications from one of several seismic sources indicating the source is not ready to perform a seismic sweep but will be ready to perform the seismic sweep within a specifically determined time. Such a specifically determined time may include 1, 2, 3, 4, 5, 6, 7, 8, 9, 10 seconds and the like. However, such a specifically determined time may also include a range such as less than 5 seconds, less than 10 seconds, less than 15 seconds, and the like. Providing such a specifically determined time provides much greater intelligence than reliance on an undetermined time (e.g., something less than infinity).

FIG. 6 illustrates an example of seismic surveying in an embodiment. In FIG. 6 instead of fleet sweeping on slip-time interval 617 (see analogous condition in FIG. 4) system 14 waits for the second fleet to arrive before sweeping at 618. This results in the seven sweeps (601, 603, 604, 606, 608, 610, 612) being acquired in significantly less time than before (i.e., line 619 shows the location of line 419 if it were included in FIG. 6) to illustrate the efficiency of the delay associated with blocks 525, 530.

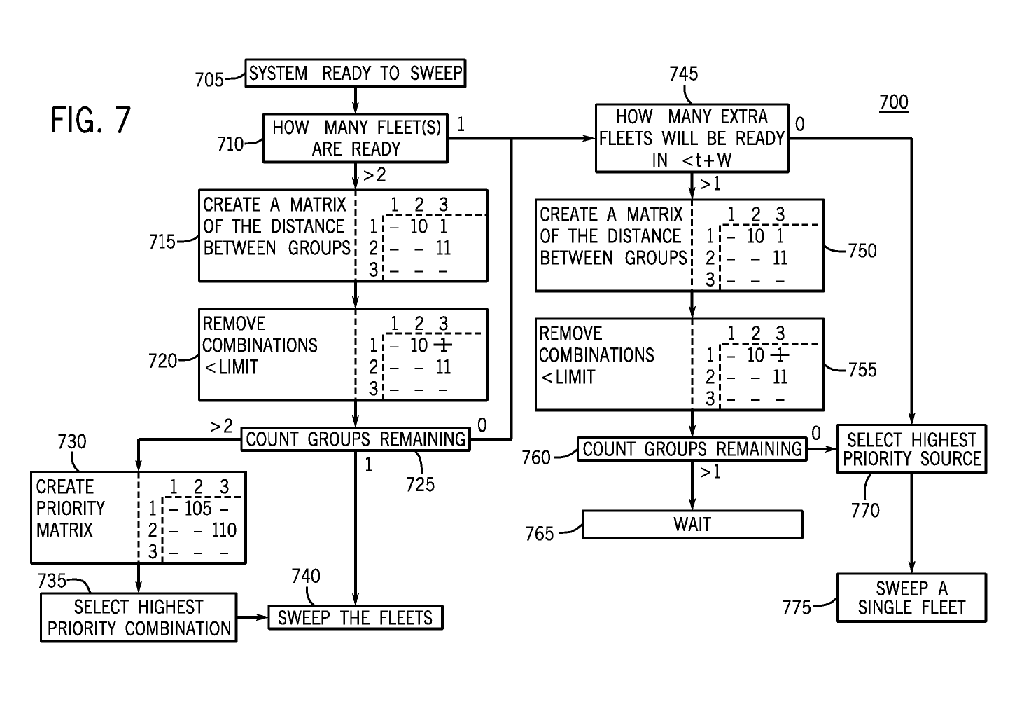

FIG. 7 includes a flow diagram for queue discipline in an embodiment. In block 705 system 14 waits. In block 710 system 14 determines how many sources are ready to perform seismic sweeps. In this example, at block 715 three sources are ready and system 14 determines distances among the three sources. For example, the distance between fleets or sources 1 and 2 is 10 units (e.g., kilometers), between fleets or sources 1 and 3 is 1 unit, and between fleets or sources 3 and 2 is 11 units. In block 720 a threshold (e.g., 5 distance units) may be used to remove source combinations that are too close to one another, such as fleet or source combination having a separation of 1 unit (which does not meet the threshold of 5 units). Thus, block 720 shows a “strike through” of the 1-3 combination. At block 725 system 14 determines whether more than one grouping is still viable for simultaneous sweeping. If only a single combination is still viable, that combination may be swept in block 740.

However, if more than one combination exists, a determination may be made as to which combination should be swept first. For example, in block 730 there are two remaining combinations from block 720 (i.e., the 1-2 and the 2-3 combinations). In block 730 a priority matrix (or other such mechanism) may be used to evaluate the priorities among the viable combinations. In this example, the 2-3 combination has a higher priority (110) than the 1-2 combination (105). Accordingly, in block 735 the 2-3 combination is selected and in block 740 that combination has its sweeps initiated by system 14. Thus, in an embodiment when first, second, and third seismic sources are determined to all be ready to perform seismic sweeps, system 14 may (a) determine a first priority for simultaneously sweeping the first and second seismic sources and a second priority for simultaneously sweeping the first and third seismic sources, and (b) initiate simultaneous seismic sweeping with the first and second seismic sources based on determining the first priority exceeds (i.e., is greater than, less than or generally unequal to) the second priority. In other embodiments, simultaneous sweeping may include simultaneously sweeping three or more groups or sources.

Returning to block 725, if no combinations were found viable system 14 may proceed to block 745. In block 745 system 14 may determine (in a manner similar to block 525 of FIG. 5) a predicted time delay that will transpire before any plurality of sources will be ready to perform seismic sweeps. System 14 may determine whether the predicted time delay meets a time threshold. For example, system 14 may set the time threshold according to when a fleet will be ready in less than the current time (t) plus the maximum waiting time (W).

If no combinations exist after the time threshold determination, non-simultaneous sweeping may occur in block 770/775 according to priority for each source. However, if more than one combination of sources passes the time threshold, then a distance threshold may be evaluated in blocks 750 and 755 in a manner analogous to blocks 715, 720. If no combination meets the threshold, then system 14 may progress to block 770. However, if one or more combinations are still viable after block 760, system 14 may wait in block 765 and thereby increase the efficiency of the overall testing procedure.

Thus, in an embodiment when more than one of first, second, and third seismic sources are determined to be unready to perform seismic sweeps, system 14 (a) determines an additional predicted time delay that will transpire before two of the first, second, and third seismic sources will be ready to perform seismic sweeps; (b) determines an additional predicted distance that will exist between the two of the first, second, and third seismic sources once the two of the first, second, and third seismic sources are ready perform seismic sweeps; (c) determines the additional predicted time delay meets the time threshold and the additional predicted distance meets the distance threshold, and then (d) initiates simultaneous seismic sweeping with the two of the first, second, and third seismic sources after the two of the first, second, and third seismic sources are ready to perform seismic sweeps.

Regarding priorities, as indicated above (e.g., block 730) if system 14 determines a first priority for simultaneously sweeping the first and second seismic sources and a second priority for simultaneously sweeping the first and third seismic sources, system 14 may initiate simultaneous seismic sweeping with the first and second seismic sources based on determining the first priority exceeds the second priority. As used herein, “exceeds” does not necessarily mean, for example, that a first priority has a higher + value than the second priority. A lower value may exceed another value when viewed from a “reverse perspective.”

Priorities may be based on, for example, whether some of the seismic sources 110 are behind schedule (FIG. 1). In this manner, controller 120 effectively assigns higher priorities to mobile seismic sources 110 that are behind schedule; and as a result, pending requests from these lagging mobile seismic sources 110 are granted before the other pending requests. Additional non-limiting examples include setting priorities to minimize the time that the seismic sources 110 spend in hazardous or inconvenient locations (e.g., military bases); maintaining seismic sources 110 in close proximity to each other (which allows mechanics to respond quickly to seismic sources 110 when repairs are required); reducing the distances that seismic sources 110 need to move when repairs are needed; reducing the times for moving seismic sources 110 between source lines; reducing the time that each receiver line is required (which means the receivers may be moved as quickly as possible to thereby decrease the chance that a lack of receivers slows down the acquisition of the survey); and helping groups that may be “struggling” (groups running short of fuel, groups in danger of breaking down, etc.) during the survey to be used little as possible without negatively impacting productivity by assigning them low priorities. The ordering in the queue may be based on other survey parameters, in accordance with other embodiments of the invention.

As explained more fully in co-pending and commonly assigned U.S. patent application Ser. No. 12/796,714, filed Jun. 9, 2010 and entitled “Controlling seismic sources in connection with a seismic survey” (hereby incorporated by reference), priorities may be maintained via use of physical or virtual queues. For example, some mobile seismic sources 110 may be behind schedule and as a result, controller 120 (FIG. 2) may circumvent default ordering (e.g., FIFO ordering) and rearrange the positions or memory locations of the requests in queue 130 to accomplish this. In an embodiment, controller 120 assigns priorities to the requests, which may change as the requests are being processed. Controller 120 may include one or more microprocessors and/or microcontrollers and may include processor 122, which executes program instructions 126 that are stored in memory 124. Memory 124 may be a memory of controller 120, although program instructions 126 may be stored in another memory, in accordance with other embodiments of the invention. In an embodiment, system 14 (FIG. 1) includes or is coupled to elements 130, 120, 122, 124, 126, and 118 (FIG. 2).

Embodiments have been discussed herein with reference to “simultaneous” sweeping. As pointed out above, simultaneous source acquisition involves two or more groups of sources emitting sweeps simultaneously. For example, each sweep may start at the same instant, end at the same instant, and/or merely overly overlap (e.g., slip-sweep acquisition) to any extent. Thus, embodiments directed to “simultaneous sweeping” are directed towards, without limitation, simultaneous shooting and slip-sweep acquisition. See, e.g., Bagaini, C., 2010, “Acquisition and processing of simultaneous vibroseis data”: Geophysical Prospecting, 58, pages 81-99. In simultaneous shooting two or more vibrators (or groups of vibrators) emit their sweeps simultaneously. Differences among acquisition methods in this category may be due to the type of sweeps adopted, the number of sweeps and the number of locations from which the source is simultaneously activated. In slip-sweep acquisition, a vibrator group starts sweeping before the end of the sweep length and listen time of the previous sweep. Slip-sweep acquisition does not require two or more vibrators to be ready at their locations at the same time. This method includes a vibrator group sweeping without waiting for the previous group's sweep to terminate. Also, “simultaneous sweeping” as used herein may include combinations of methods, such as combinations of simultaneous shooting and slip-sweep acquisition.

Thus, as noted above (see, e.g., passages related to FIGS. 5 and 7) various embodiments described herein do not necessarily require that two sources involved in simultaneous sweeping necessarily both be ready at the same time. For example, an embodiment may include a software program that enables system 14 to determine whether first and second seismic sources are ready to perform simultaneous seismic sweeping. This may mean determining whether each seismic source, at that particular instant, is ready to begin the physical act of imparting a seismic source signal into the earth. However, this may also mean only one of the sources is, at that particular instant, ready to begin the physical act of imparting a seismic source signal into the earth. However, the other source will be ready to begin the physical act of imparting a seismic source signal into the earth while the first source is still sweeping (even though the second source may not be ready to impart a seismic source signal into the earth at the very beginning of the first source's sweep). For example, with “dithered acquisition” there may be a time delay of a couple of hundred milliseconds between sweeps. Specifically, system 14 may determine that if a second source were to be ready in, for example, 0.5 seconds (and a first source is already ready to sweep) then system 14 may start a first source sweeping after waiting 0.3 seconds and the second source sweeping when it is ready. Thus, there would be a “dither” of 0.2 seconds.

With this explanation of determining whether first and second seismic sources are ready to perform simultaneous seismic sweeping in mind, an embodiment may provide for system 14 to function as follows. When the first and the second seismic sources are determined to both be ready to perform simultaneous seismic sweeping (e.g., simultaneous shooting and/or slip-sweep acquisition), system 14 may initiate simultaneous seismic sweeping with the first and second seismic sources based on determining a distance between the first and second seismic sources meets a distance threshold. Also, when either of the first and the second seismic sources are determined to be unready to perform simultaneous seismic sweeping, system 14 may (a) determine a predicted time delay that will transpire before the first and the second seismic sources will both be ready to perform simultaneous seismic sweeping (e.g., simultaneous shooting and/or slip-sweep acquisition); (b) determine a predicted distance that will exist between the first and second seismic sources once the first and second sources are both ready to perform simultaneous seismic sweeping; (c) determine the predicted time delay meets a time threshold and the predicted distance meets the distance threshold, and then (d) initiate simultaneous seismic sweeping with the first and second seismic sources after the first and the second seismic sources are both ready to perform simultaneous seismic sweeping (e.g., simultaneous shooting and/or slip-sweep acquisition).

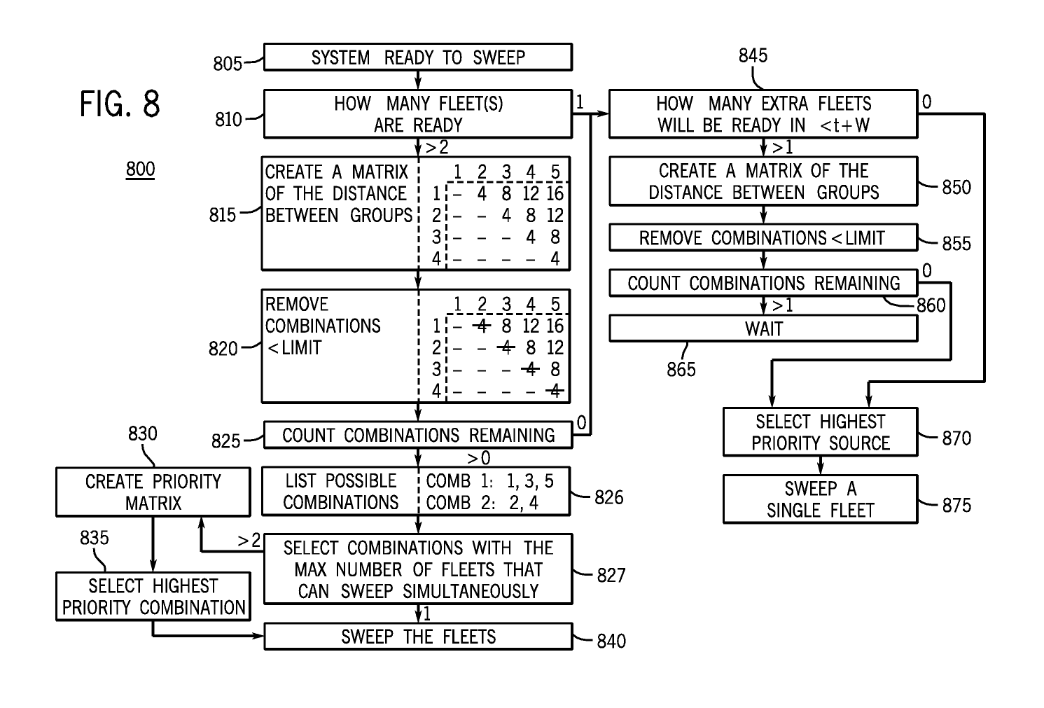

Embodiments are not limited to any set number of vibrators or vibrator groups. For example, in an embodiment it may be possible to acquire more than two fleets simultaneously. FIG. 8 includes a flow diagram for queue discipline in an embodiment. Blocks 805, 810, 845, 850, 855, 860, 865, 970, 875, 830, 835, and 840 are analogous to respective counterparts 705, 710, 745, 750, 755, 760, 765, 770, 775, 730, 735, and 740 of FIG. 7 and are not addressed again for the sake of brevity. In block 815 five sources (or source groups) are ready and system 14 determines distances among the sources. For example, the distance between fleets or sources 1 and 2 is 4 units (e.g., kilometers), between fleets or sources 1 and 3 is 8 units, between fleets or sources 1 and 4 is 12 units, and between fleets or sources 1 and 5 is 16 units. Other combinations are shown in block 815. In block 820 a threshold (e.g., 5 distance units) may be used to remove source combinations that are too close to one another, such as fleet or source combination having a separation of 4 units (which does not meet the threshold of 5 units). Thus, block 820 shows a “strike through” of several combinations with separation of 4 units (e.g., 1-2 combination). At block 825 system 14 determines whether more than one grouping is still viable for simultaneous sweeping. If only a single combination is still viable, that combination may be swept in block 840.

However, if more than one combination exists, a determination may be made as to which combination should be swept first. For example, in block 826 system 14 may determine the possible combinations of sources. A first combination may include groups 1, 3, and 5 while a second combination only includes groups 2 and 4. (While block 826 does not include every combination for purposes of clarity, other such combinations may include 1 and 3, 1 and 4, 1 and 5, 2 and 5, and 3 and 5). In block 827 system 14 may select the first combination because it has more vibrators (3) that can sweep simultaneously than the second combination (only 2). Block 827 may then feed to blocks 830 or 840 as described above. For example, with block 830 a priority matrix may be used to decide among two combinations each including an equivalent number of sources. However, blocks 830 and 835 may be omitted in various embodiments.

Thus, in an embodiment a system such as system 14 may initiate simultaneous seismic sweeping with first and second seismic sources based on a determination that the first and second seismic sources are included in a grouping of ready seismic sources (e.g., the first combination of block 826) that is larger in number than any other grouping of ready seismic sources (e.g., the second combination of block 826).

Embodiments have been described herein that focus on predicting both time delays and inter-source distance. However, embodiments may include predicting just time delays or just inter-source distance or neither of the two. For example, some simultaneous sweeping may not require two sources be separated by any minimum distance. In that instance, queue discipline may not include requirements tied to determining inter-source distance.

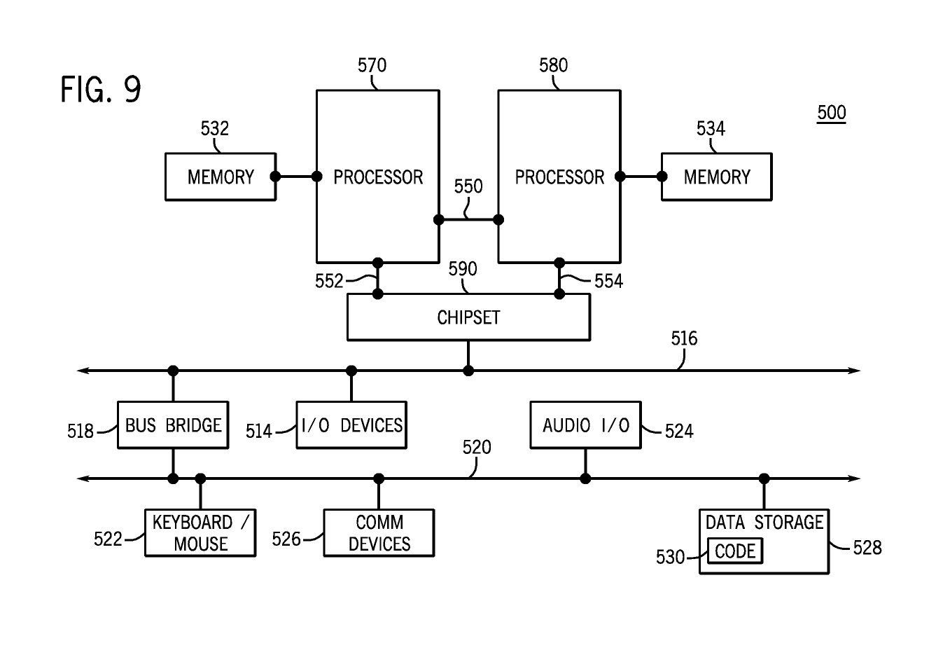

Embodiments may be implemented in many different system types. Referring now to FIG. 9, shown is a block diagram of a system, such as system 14, in accordance with an embodiment of the present invention. Multiprocessor system 500 is a point-to-point interconnect system, and includes a first processor 570 and a second processor 580 coupled via a point-to-point interconnect 550. Each of processors 570 and 580 may be multicore processors. The term “processor” may refer to any device or portion of a device that processes electronic data from registers and/or memory to transform that electronic data into other electronic data that may be stored in registers and/or memory. First processor 570 may include a memory controller hub (MCH) and point-to-point (P-P) interfaces. Similarly, second processor 580 may include a MCH and P-P interfaces. The MCHs may couple the processors to respective memories, namely memory 532 and memory 534, which may be portions of main memory (e.g., a dynamic random access memory (DRAM)) locally attached to the respective processors. First processor 570 and second processor 580 may be coupled to a chipset 590 via P-P interconnects, respectively. Chipset 590 may include P-P interfaces. Furthermore, chipset 590 may be coupled to a first bus 516 via an interface. Various input/output (I/O) devices 514 may be coupled to first bus 516, along with a bus bridge 518, which couples first bus 516 to a second bus 520. Various devices may be coupled to second bus 520 including, for example, a keyboard/mouse 522, communication devices 526, and data storage unit 528 such as a disk drive or other mass storage device, which may include code 530, in one embodiment. Further, an audio I/O 524 may be coupled to second bus 520.

Embodiments may be implemented in code and may be stored on a storage medium having stored thereon instructions which can be used to program a system to perform the instructions. The storage medium may include, but is not limited to, any type of disk including floppy disks, optical disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Embodiments of the invention may be described herein with reference to data such as instructions, functions, procedures, data structures, application programs, configuration settings, code, and the like. When the data is accessed by a machine, the machine may respond by performing tasks, defining abstract data types, establishing low-level hardware contexts, and/or performing other operations, as described in greater detail herein. The data may be stored in volatile and/or non-volatile data storage. For purposes of this disclosure, the terms “code” or “program” cover a broad range of components and constructs, including applications, drivers, processes, routines, methods, modules, and subprograms. Thus, the terms “code” or “program” may be used to refer to any collection of instructions which, when executed by a processing system, performs a desired operation or operations. In addition, alternative embodiments may include processes that use fewer than all of the disclosed operations, processes that use additional operations, processes that use the same operations in a different sequence, and processes in which the individual operations disclosed herein are combined, subdivided, or otherwise altered.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
determining (a) a predicted time delay that will transpire before first and second seismic sources are ready to perform simultaneous seismic sweeping (SSS); and (b) a predicted distance that will exist between the first and second seismic sources once the first and second sources are ready to perform SSS;
assessing whether the predicted time delay meets a time threshold and the predicted distance meets a distance threshold; and
initiating SSS with the first and second seismic sources after the first and the second seismic sources are both ready to perform SSS.

2. The method of claim 1 including receiving communications from one of the first and second seismic sources indicating the one of the first and second seismic sources is not ready to perform SSS but will be ready to perform SSS within a specifically determined time.

3. The method of claim 1 including determining the predicted time delay based on data concerning a previous move-up time for one of the first and second seismic sources.

4. The method of claim 1 including determining the predicted distance based on data concerning generally real-time location tracking for one of the first and second seismic sources.

5. The method of claim 1, including when the first and second seismic sources and a third seismic source are determined to all be ready to perform SSS, (a) determining a first priority for simultaneously sweeping the first and second seismic sources and a second priority for simultaneously sweeping the first and third seismic sources, and (b) initiating SSS with the first and second seismic sources based on determining the first priority exceeds the second priority.

6. The method of claim 1, including when more than one of the first and second seismic sources and a third seismic source are determined to be unready to perform SSS, (a) determining an additional predicted time delay that will transpire before two of the first, second, and third seismic sources will be ready to perform SSS; (b) determining an additional predicted distance that will exist between the two of the first, second, and third seismic sources once the two of the first, second, and third seismic sources are ready to perform SSS; (c) assessing whether the additional predicted time delay meets the time threshold and the additional predicted distance meets the distance threshold, and then (d) initiating SSS with the two of the first, second, and third seismic sources after the two of the first, second, and third seismic sources are ready to perform SSS.

7. The method of claim 1, wherein (a) the first and second seismic sources respectively include first and second mobile seismic vibrators, (b) assessing whether the distance between the first and second seismic sources meets the distance threshold includes assessing whether the distance is less than the distance threshold, and (c) assessing whether the predicted time delay meets the time threshold includes assessing whether the predicted time delay is less than the time threshold.

8. The method of claim 1 including when more than one of the first and second seismic sources and a third seismic source are determined to be unready to perform SSS, (a) determining first and second predicted time delays that will respectively transpire before first and second seismic source pluralities of the first, second, and third seismic sources will be ready to perform SSS; (b) assessing whether the first and second predicted time delays each meet the time threshold, (c) respectively determining first and second priorities for simultaneously sweeping the first and second seismic source pluralities, and (d) initiating SSS with the first seismic source plurality based on determining the first priority exceeds the second priority.

9. An article comprising a non-transitory medium storing instructions that enable a processor based system to:
determine a predicted time delay that will transpire before first and second seismic sources will both be ready to perform simultaneous seismic sweeping (SSS);
determine a predicted distance that will exist between the first and second seismic sources once the first and second sources are both ready to perform SSS; and
based on the predicted time delay and the predicted distance, initiate SSS with the first and second seismic sources after the first and the second seismic sources are both ready to perform SSS.

10. The article of claim 9 storing instructions that enable the system to receive communications from one of the first and second seismic sources indicating the one of the first and second seismic sources is not ready to perform SSS but will be ready to perform SSS within a specifically determined time.

11. The article of claim 9 storing instructions that enable the system to (a) determine the predicted time delay based on data concerning a previous move-up time for one of the first and second seismic sources; and (b) initiate SSS with the first and second seismic sources based on a determination that the first and second seismic sources are included in a grouping of ready seismic sources that is larger in number than any other grouping of ready seismic sources.

12. The article of claim 9 storing instructions that enable the system to determine the predicted distance based on data concerning generally real-time location tracking for one of the first and second seismic sources.

13. The article of claim 9 storing instructions that enable the system to:
when the first and second seismic sources and a third seismic source are determined to all be ready to perform SSS, (a) determine a first priority for simultaneously sweeping the first and second seismic sources and a second priority for simultaneously sweeping the first and third seismic sources, and (b) initiate SSS with the first and second seismic sources based on determining the first priority exceeds the second priority.

14. The article of claim 9 storing instructions that enable the system to:
when more than one of the first and second seismic sources and a third seismic source are determined to be unready to perform SSS, (a) determine an additional predicted time delay that will transpire before two of the first, second, and third seismic sources will be ready to perform SSS; (b) determine an additional predicted distance that will exist between the two of the first, second, and third seismic sources once the two of the first, second, and third seismic sources are ready to perform SSS; and (c) initiate SSS with the two of the first, second, and third seismic sources after the two of the first, second, and third seismic sources are ready to perform SSS.

15. The article of claim 9 storing instructions that enable the system to assess whether the predicted time delay meets a time threshold and the predicted distance meets a distance threshold.

16. A system comprising:
a memory coupled to a processor, the processor to: (a) determine a predicted time delay that will transpire before first and the second seismic sources will both be ready to perform simultaneous seismic sweeping (SSS); and (b) initiate SSS with the first and second seismic sources after the first and the second seismic sources are both ready to perform SSS.

17. The system of claim 16, wherein the processor is to receive communications from one of the first and second seismic sources indicating the one of the first and second seismic sources is not ready to perform a SSS but will be ready to perform SSS within a specifically determined time.

18. The system of claim 16, wherein the processor is to:
determine a predicted distance that will exist between the first and second seismic sources once the first and second sources are both ready to perform SSS; and
determine one of (a) the predicted time delay based on data concerning a previous move-up time for one of the first and second seismic sources, and (b) the predicted distance based on data concerning generally real-time location tracking for one of the first and second seismic sources.

19. The system of claim 16, wherein the processor is to:
when the first and second seismic sources and a third seismic source are determined to all be ready to perform SSS, (a) determine a first priority for simultaneously sweeping the first and second seismic sources and a second priority for simultaneously sweeping the first and third seismic sources, and (b) initiate SSS with the first and second seismic sources based on determining the first priority exceeds the second priority.

20. The system of claim 16, wherein the processor is to:
when more than one of the first and second seismic sources and a third seismic source are determined to be unready to perform SSS, (a) determine an additional predicted time delay that will transpire before two of the first, second, and third seismic sources will be ready to perform SSS; (c) and initiate SSS with the two of the first, second, and third seismic sources after the two of the first, second, and third seismic sources are ready to perform SSS.
